(19) United States
(12) Patent Application Publication
(10) Pub. No.: US 2008/0187424 A1
(43) Pub. Date: Aug. 7, 2008

(54) Transport For A Wind Tower And Methods Thereof

(76) Inventors: Alberto M. Garcia, Shreveport, LA (US); Patrick C. Lashley, Shreveport, LA (US); Garland W. Brown, Gainesville, TX (US); David G. Porter, Gainesville, TX (US)

Correspondence Address: BUSKOP LAW GROUP, P.C., 4511 Dacoma Street, HOUSTON, TX, 77092, US

(21) Appl. No.: 11/671,924

(22) Filed: Feb. 6, 2007

(51) Int. Cl. B60P 1/00

(52) U.S. Cl. 414/469

(57) ABSTRACT

A transport, comprising an axle and at least two wheels supporting a chassis. A main support is connected to the chassis, wherein the main support comprises bottom engaging means and a locking means. A load cylinder is connected to the main support, wherein the load cylinder comprises a top engaging means. A mast cylinder is connected to the top engaging means and the bottom engaging means.

### CROSS REFERENCE TO RELATED APPLICATIONS

### FIELD

The embodiments relates to methods and systems for supporting a self-supporting load on undercarriages or axle systems for the purpose of transport thereof. The term undercarriage or axle system is here understood to mean any chassis part with one or more axles.

### BACKGROUND

Manners for suspending a self-supporting load, for instance so-called tower sections, for transport on the road or on a construction site, between two undercarriages are known. The tower section is mounted using a trailing dolly and a towing dolly. On both ends of the tower section is then mounted an adapter, the foremost of which is provided with a coupling pin which can be connected to the kingpin of the towing unit. The rear adapter is placed in similar manner on the trailing dolly. The tower section itself herein functions as if the tower section was the chassis of the trailer formed by the tower section, the two adapters and the trailing dolly.

The adapter used in the known methods consists of a rigid, rectangular or square, standing frame which is fixed to an end surface of the tower section. Protruding from this standing frame are two lying and two inclining beams which form two triangular side frames. These side frames are in turn connected by a cross beam which carries the coupling pin in the middle.

A drawback of the known methods is that the adapter used therein cannot be adapted to the dimensions of the tower section for transporting. Since masts of wind turbines generally taper toward the top, the tower sections all have different diameters, so that the adapter, which will be dimensioned for the largest (lower) tower part, is in fact too large for the other tower parts. In addition, the adapter comes under relatively great strain of bending, since at the top and bottom the standing frame protrudes beyond the lying and inclining beams of the side frames. In tun, the adapter has to be very strong and therefore of heavy construction, whereby the payload of the combination of trailing dolly and a towing dolly for a given total weight or axle load is limited. Finally, the adapter is relatively long, whereby the length of the trailing dolly and a towing dolly combination becomes very great and is difficult to maneuver.

In addition, an adapter is already known that has a standing frame with a telescopic embodiment and can thus be adapted to the dimensions of the tower section by being retracted or extended. This adapter is even heavier than a fixed adapter and has the same drawbacks in respect of the construction length.

### BRIEF DESCRIPTION OF THE DRAWINGS

The detailed description will be better understood in conjunction with the accompanying drawings as follows:

FIG. 1 depicts a side view of the transport

FIG. 2 depicts a top view of the main support

The present embodiments are detailed below with reference to the listed Figure.

### DETAILED DESCRIPTION OF THE EMBODIMENTS

Before explaining the present embodiments in detail, it is to be understood that the embodiments are not limited to the particular description and that they can be practiced or carried out in various ways.

The embodiments provide a method and system for supporting a transportable load, such as a wind tower, wherein the end of the load is engaged directly by one or more engaging connections and one or more tipper engaging connections. The engaging connections are connected to the undercarriage and enclose an angle in a vertical plane. By making use for the support of the load of supports that engage directly on the load, the use of separate adapters with heavy frames, which take up space, are not needed.

The systems provide a transport with a mast cylinder connecting the top engaging connections to the bottom engaging connections. The direct connection between the top and bottom engaging connections using a mast cylinder provided a stronger grip on the transportable load or wind tower than those in the prior art.

The systems provide a transport with a locking mechanism on the main frame. The main frame can be the structure in which the transport is connected to the chassis. The chassis can be a chassis of a vehicle in which the transport is connected to, the vehicle can vehicles such as trucks, cars, trailers, or movable platforms in which can be towed by motorized vehicles. When the transportable load is being carried, the load cylinder rests on the locking mechanism. In this configuration, the weight of the load and the longitudinal forces are on the locking mechanism and the chassis. The weight of the load and the longitudinal forces are not placed on the cylinders during transport. This configuration provides an improvement or previous transports in that the weight is typically placed on the cylinders that can easily fail during transport.

In one embodiment, the transport has one or more axles, wherein each axle has two or more wheels. The axles and wheels support a chassis that can be towed by a vehicle. During a typical transport, the transportable load is carried between a trailing dolly and a towing dolly. For purposes herein, the transport refers to either the trailing dolly or the towing dolly.

A main support is connected to the chassis and extends from the chassis towards the transportable load. The main support has bottom engaging means or a bottom engaging mechanism located at the end of the main support farthest from the chassis. The bottom engaging mechanism connects to the bottom side of the transportable load.

A load cylinder connected is connected to the main support. In one embodiment, the load cylinder is connected to the main support at the end of the main support connected to the chassis. In order to limit the loads on the main support or the load cylinder while picking-up or off-loading the transportable load, the main support and the load cylinder converge at or close to a point where the forces are transmitted into the chassis.

The angle between the main support and the load cylinder can be adapted to the dimensions of the end of the transportable load in order to allow the transport to carry a wide range of sizes of transportable loads. The angle between the main support and the load cylinder is optimized during loading so that the weight of the load and the longitudinal forces are distributed appropriately between the main support and the load cylinder to avoid failure of either. During loading, the main support and the load cylinder are loaded substantially by only longitudinal forces and can be given a relatively light form. In one example construction, the main support is non-adjustable adjustable and runs substantially horizontally, while the load cylinders projects from the main support from an acute angle.

During transport a locking mechanism located on the main support connects with the load cylinder so that the load on the load cylinder is transferred to the main support and the chassis. In one embodiment, the locking mechanism is located near the midpoint of the main support, but can alternatively be moveable along the main support in order to allow the user to find the optimal location to connect to the load cylinder.

Returning to the load cylinder, the load cylinder extends from the chassis or from the connection with the main support towards the transportable load. The load cylinder itself is extendable in order to vary the length. The load cylinder has top engaging means or a top engaging mechanism located at the end of the load cylinder farthest from the chassis. The top engaging mechanism connects to the top side of the transportable load.

The top engaging mechanism and the bottom engaging mechanism are connected by a mast cylinder.

The load cylinder should be in the same plane as the main support. To ensure a stable support of the load, the transport can include a beam or connection between the main support and the load cylinder so that the main support and the load cylinder are oriented accurately relative to each other under all conditions. The load cylinder and main support move relative to each other for the purpose of adjusting the angle enclosed there between, whereby the transport can be adapted to the dimensions of the load. A device which is easy to handle is obtained here when hydraulic, pneumatic and/or mechanical means are present to cause movement of the load cylinder and main support relative to each other. In one construction, the main support and load cylinder are placed successively into engagement with a transportable load and then moved to a position in which the transportable load is lifted. In this manner the load can be picked up quickly and easily.

The main support and/or the load cylinder can be rotatably connected to the chassis relative to the axle. This rotation connection allows the transport to pick-up and off-load when the transportable load is not accessible to the central axis of the transport. The rotation connection allows for the ease of transport is maneuvering around turns during transport loads. A blocking means can be connected to the chassis to limit or stop the main support or load cylinder from rotating relative to the axle.

As to maneuverability of the transport formed by the load and the undercarriages, the bottom engaging means can be rotatable relative to the chassis. So as to prevent the transport—which is formed by the chassis of a trailing dolly, the chassis of the towing dolly, and the transportable load there between—from becoming unstable at higher speeds.

The embodiments provide methods for supporting a transportable load, in particular a tower section. A transport is placed near the transportable load. Optimally, the central axis of the transportable load aligns to the central axis of the transport. If this alignment is not possible, the main support and load cylinder are aligned to the central axis of the transportable load. Initially, the load cylinder and the mast cylinder are fully retracted. The main support is then lowered so far that the bottom engaging mechanism is just clear of the ground. In this position the transport is moved toward transportable load by moving the entire chassis. The bottom engaging mechanism is then fixed onto the bottom side of the transportable load.

The mast cylinder is then extended so the top engaging mechanism is slightly inside the transportable load. The mast cylinder is then extended until the top engaging mechanism connects with the top side of the transportable load. In order to ensure that the top engaging mechanism makes an optimal connection with the top side of the transportable load, the mast cylinder can be extended and retracted as the mast cylinder is raised.

The opposite of the end of the transportable load is connected to a transport is a similar manner.

Once both ends of the transportable load are connected to transports, the main support is raised thereby raising the transportable load. The load cylinder and the position of the chassis are also manipulated so that the central axis of the transportable load is parallel to the ground.

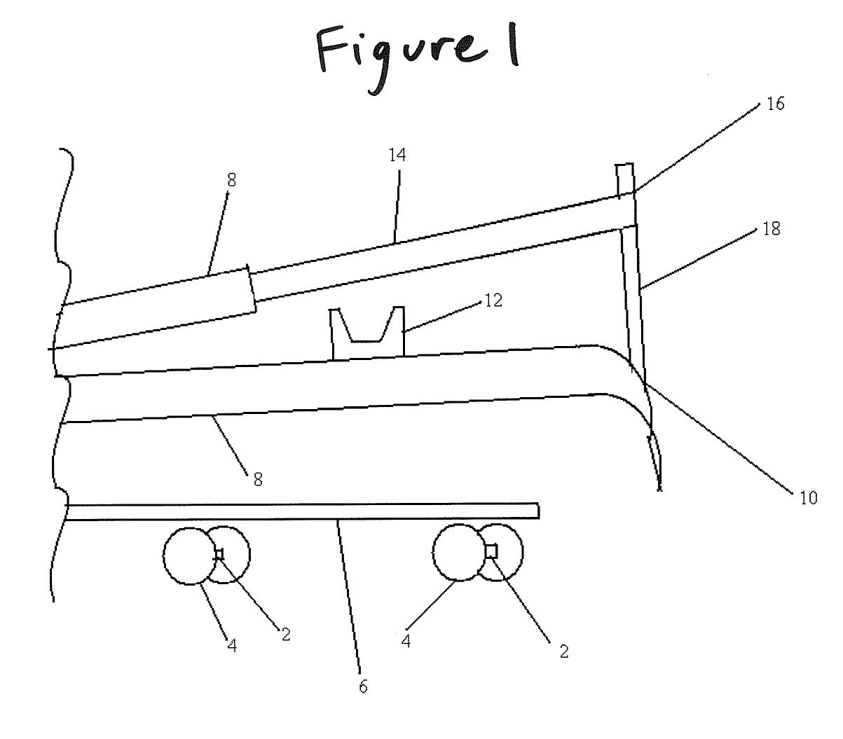

With reference to the figures, FIG. 1 depicts a transport. The transport has axles 2 and wheels 4. The axles 2 and wheels 4 are used to support the chassis 6. The main support 8, with a bottom engaging means 10, and a locking means 12 is connected to the chassis. A load cylinder 14 is connected to the main support. The load cylinder has a top engaging means 16 connected to a mast cylinder 18. The mast cylinder 18 is additionally connected to the bottom engaging means 10.

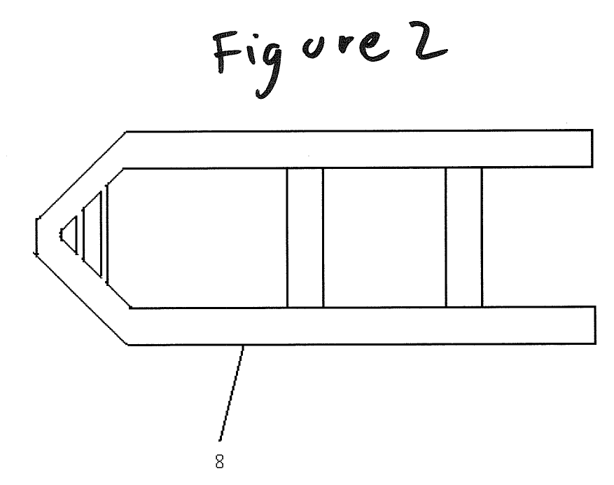

FIG. 2 depicts a top view of the main support 8.

The top and bottom engaging means that engage directly on the transportable load can have diverse dimensions. Furthermore, because some of the supports absorb the weight of the load and only tensile forces act on the other supports, the use of relatively heavy and voluminous adapters can be dispensed with, whereby the weight of the transportable load can be higher at a given weight of the combination, and the combination is easier to maneuver.

As to alternative embodiments, the transport can utilize more or fewer supports than shown herein, while the form and configuration thereof can also be varied. In addition, moving mechanisms other than the shown hydraulic cylinders can be applied. Connections between the supports and the load other than the plates shown here can be used and not affected the novelty of the transport. Different support devices can further be used on the front and rear side of the transportable load, wherein a device according to the embodiments can be combined with a conventional trailer.

While these embodiments have been described with emphasis on the embodiments, it should be understood that within the scope of the appended claims, the embodiments might be practiced other than as specifically described herein.

What is claimed is:

1. A transport, comprising:
a. an axle and at least two wheels supporting a chassis;
b. a main support connected to the chassis, wherein the main support comprises bottom engaging means and a locking means;
c. a load cylinder connected to the main support, wherein the load cylinder comprises a top engaging means; and
d. a mast cylinder connected to the top engaging means and the bottom engaging means.

2. The transport of claim 1, wherein the top engaging means and the bottom engaging means connects to one end of a transportable load, and wherein a second transport connects to opposite end of the transportable load.

3. The transport of claim 2, wherein the second transport comprises:
a. a second axle and at least two second wheels supporting a second chassis;
b. a second main support connected to the second chassis, wherein the second main support comprises second bottom engaging means and second locking means;
c. a second load cylinder connected to the second main support, wherein the second load cylinder comprises second top engaging means; and
d. a second mast cylinder connected to the second top engaging means and the second bottom engaging means.

4. The transport of claim 1, wherein the locking means supports the load cylinder when the transport is carrying a transportable load.

5. The transport of claim 1, wherein the bottom engaging means are at least two connectors.

6. The transport of claim 1, wherein the load cylinder to the main support movable relative to each other to adjust to an angle suitable for carrying a transportable load.

7. The transport of claim 1, wherein the load cylinder and the mast cylinder are utilize hydraulic cylinders.

8. The transport of claim 1, wherein the main support is rotatably connected to the chassis relative to the axle.

9. The transport of claim 8, further comprising blocking means connected to the main support to maintain the main support from rotating relative to the axle.

10. A method for moving a wind tower comprising the steps of:
a. locating a transport adjacent to the wind tower, wherein the wind tower comprises a top side and a bottom side, and wherein the transport comprises
i. an axle and at least two wheels supporting a chassis;
ii. a main support connected to the chassis, wherein the main support comprises bottom engaging means and locking means;
iii. a load cylinder connected to the main support, wherein the load cylinder comprises top engaging means; and
iv. a mast cylinder connected to the top engaging means and the bottom engaging means.

11. The method of claim 10, wherein the transportable load is a wind tower.
